(19) United States
(12) Patent Application Publication
(10) Pub. No.: US 2015/0367515 A1
(43) Pub. Date: Dec. 24, 2015

(54) EQUIPMENT FOR TAKING A BENT PIPE

(71) Applicant: CRIPPA S.p.A., Arosio (CO) (IT)

(72) Inventors: Alessandro Pace, Arosio (CO) (IT); Claudio Bargna, Arosio (CO) (IT)

(21) Appl. No.: 14/744,364

(22) Filed: Jun. 19, 2015

(30) Foreign Application Priority Data
Jun. 20, 2014 (IT) MI2014A001128

(51) Int. Cl. B25J 9/16; B65B 7/16; B25J 15/00; B65B 5/04

(52) U.S. Cl. CPC B25J 9/1679; B65B 5/04; B65B 7/16; B25J 15/0019; Y10S 901/27; Y10S 901/30

(57) ABSTRACT

Equipment for taking a bent pipe provided with a mechanical arm, preferably featuring three degrees of freedom, operated by first means controlled by at least one preferably programmable first electronic device, and equipped with at least one container located at an end of the arm, means facilitating the unloading of the bent pipe into the container, and means to close it and to unload the bent pipe

### TECHNICAL FIELD

The equipment according to the present invention concerns a mechanical arm operated by at least one electronic device. The arm is equipped, at one of its ends, with a container suitable for the taking of a bent pipe at the end of the bending process, this way solving the drawbacks affecting the equipment known so far, among which the uncontrolled fall of the bent pipe or the complexity found in programming the mechanical arm handling electronic control device.

### STATE OF THE ART

Bent pipes are used in many industrial sectors. They are produced by using pipe bending machines capable of producing sections of pipe featuring pre-set lengths and shapes.

The pipe bending process comprises the shaping of sections of a common rectilinear pipe of a standard length to obtain at least one bent pipe manufactured piece featuring pre-set length and curvilinear shape, briefly referred to below as bent pipe or manufactured piece.

To obtain such a manufactured piece, the rectilinear pipe is shaped according to a pre-set manufacturing program and cut, so as to separate the manufactured piece from the common rectilinear pipe, which will be subsequently bent to obtain another manufactured piece and so on for the complete length of the rectilinear pipe.

The manufactured piece separated from the rectilinear pipe shall be picked up immediately after being expelled from the pipe bending machine to be collected according to a specific program.

Very often are the individual bent pipes, obtained at the end of the bending process, collected in trolleys to be transported to the various work positions and used to manufacture a variety of articles, for instance legs of chairs or different applications in the car industry. Said manufactured pieces are also stored to be subsequently sent to other plants for their use, already illustrated.

The techniques known so far adopt one of the three following methods to pick-up a manufactured piece expelled from the pipe bending machine at the end of the cutting step:
(i) by uncontrolled fall of the manufactured piece into a container, with its respective drawbacks related to the damages possibly occurring to the manufactured piece itself or to other manufactured pieces already present in said container;
(ii) manually by means of an operator, with its respective drawbacks related to the non-automation of this step of the production process;
(iii) by means of an industrial robot which grips the manufactured pieces by the pincers it is provided with. In the latter case, adopting an industrial robot to unload the bent pipe is an approach similar to that described in (ii) above, but solves the drawback related to the non-automation of that step of the production process.

However, programming the software that controls the industrial robot is a complex task and such complexity is a major drawback in our case. It is known that, in the usual industrial production that uses bent pipes, manufactured pieces featuring different bending radii and lengths are used. The bent pipe gripping operation shall be performed by an equipment capable of gripping manufactured pieces of different lengths and shapes.

Because of this latter circumstance, difficulties are born in the adoption of industrial robots as manufactured piece gripping equipment. Programming an industrial robot is not very simple and requires a number of programming, depending on the number of manufactured pieces to be gripped by the subject equipment.

The drawbacks illustrated above for the methods adopted by the known techniques to take a manufactured piece upon its expulsion from the pipe bending machine are solved by the equipment according to the present invention, which offers other advantages as described in the next paragraph.

### DISCLOSURE OF THE INVENTION

The equipment for taking the bent pipe is the subject of the present invention, it comprises a mechanical arm operated by first means controlled by at least one first electronic device. The mechanical arm is provided with at least one container which is located at an end of the arm. The device according to the present invention is thus capable of advantageously the taking of a manufactured piece of any shape, length, and dimensions.

This feature solves the problems related to:
(a) free fall of the manufactured piece, as per item (i) in the previous paragraph. This result is achievable because the arm and the container can be positioned at the appropriate height to collect the bent pipe immediately after its expulsion from the pipe bending machine, thus substantially zeroing the pipe taking drawbacks according to this known technique;
(b) no-automation of the bend pipe gripping method as per item (ii) in the previous paragraph;
(c) difficulties in programming industrial robots, being it not necessary to make multiple programming as a function of the number of manufactured pieces to take. As a matter of fact, it is sufficient to program the device to position the arm and the container in the concerned area and at the appropriate height to collect the bent pipe immediately after its expulsion from the pipe bending machine, this way avoiding the multiple programming depending on the number of manufactured pieces to take.

The equipment according to the present invention features a programmability of the mechanical arm electronic control device with at least three degrees of freedom. This way, the mechanical arm is able to freely move in the space and consequently to displace the container from its idle position to the bent pipe taking one while occupying as small volumes as possible: think, for instance, to the travel of a box-shaped container from the idle zone to the pipe taking one in a vertical position, and the horizontal position which is taken again just upon reaching the bent pipe taking zone. Likewise the container can move from the one or several manufactured pieces taking zone to the unloading one in order to continue the production activity or to store it/them. In order to achieve the latter advantage related to the possibility of displacing a loaded container while occupying reduced volumes, the container is provided with third means (8) suitable for closing it.

The container is also provided with second means suitable for unloading one or several manufactured pieces from the container to continue the production activity or to store them in the area reserved therefore according to the factory's layout.

The manufactured piece expelled from the pipe bending machine can be taken by letting the manufactured piece expelled from the machine fall into the container previously brought to the appropriate height, but preferably by taking the manufactured piece and placing it in the container through at least one second device used to facilitate its unload.

### DESCRIPTION OF THE DRAWINGS

FIGS. 1 to 3 show a perspective view of an embodiment of the equipment according to the present invention. Said figures also show a pipe bending machine and other machineries, which are not numbered because they are not part of the present invention and are just shown in the figures to emphasize the advantageous features of the subject invention.

FIG. 1 shows the mechanical arm of the equipment taking a bent pipe according to the present invention. The mechanical arm is operated by first means (2), not shown in the figure, which are controlled by at least one, preferably programmable first electronic device (3), not shown in the figure. The arm (i) is provided with at least one container (4) located at an end (5) thereof. The container (4) is in turn provided with a second device (6) facilitating the unload of the bent pipe into the container (4), thus making the taking of the bent pipe even easier. FIG. 2 graphically shows the second device (6) as consisting of an inclined plane with a polyurethane surface which makes the bent pipe slowly slip into the container (4). This graphical representation is just an example of the second device (6), but it does not limit the scope of the claims in any way.

FIG. 2 shows the mobility and programmability of the arm (i) with at least three degrees of freedom. Such a freedom makes it possible to move the container (4) and, for instance, to displace the container (4) from the idle position to the bent pipe taking one while occupying as little volumes as possible, as shown in FIG. 2, the container (4) being moved to a vertical position. To provide the arm (i) with the maximum displacement capabilities and the maximum degrees of freedom, the container (4) is provided with third means (8) suitable for closing the container (4).

FIG. 3 shows the arm (i), the container (4) being unloading one or several bent pipes thanks to second means (7) suitable for unloading the bent pipe, the container (4) being provided with said second means (7).

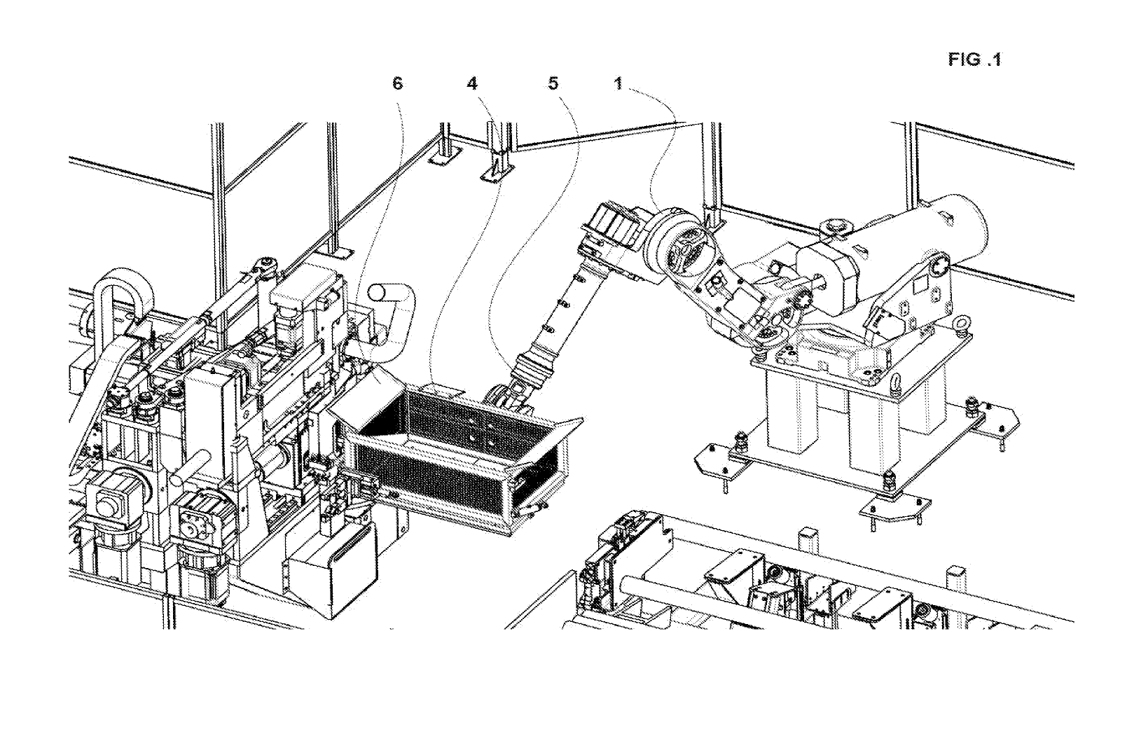

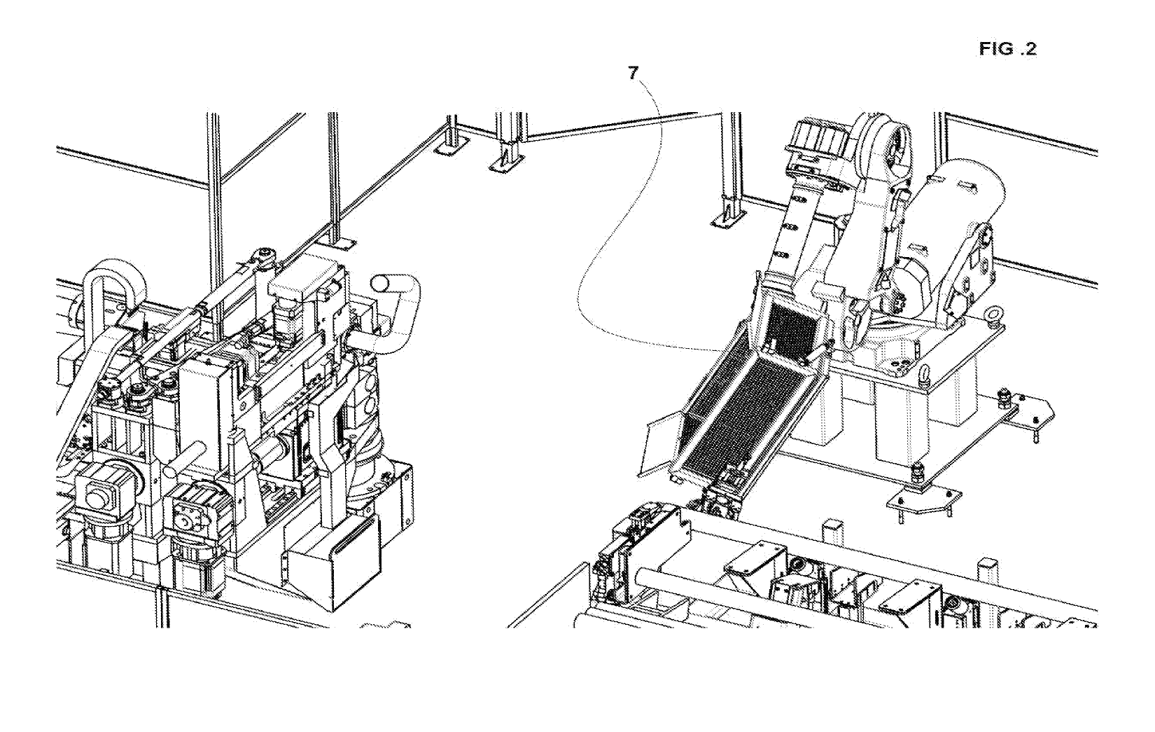

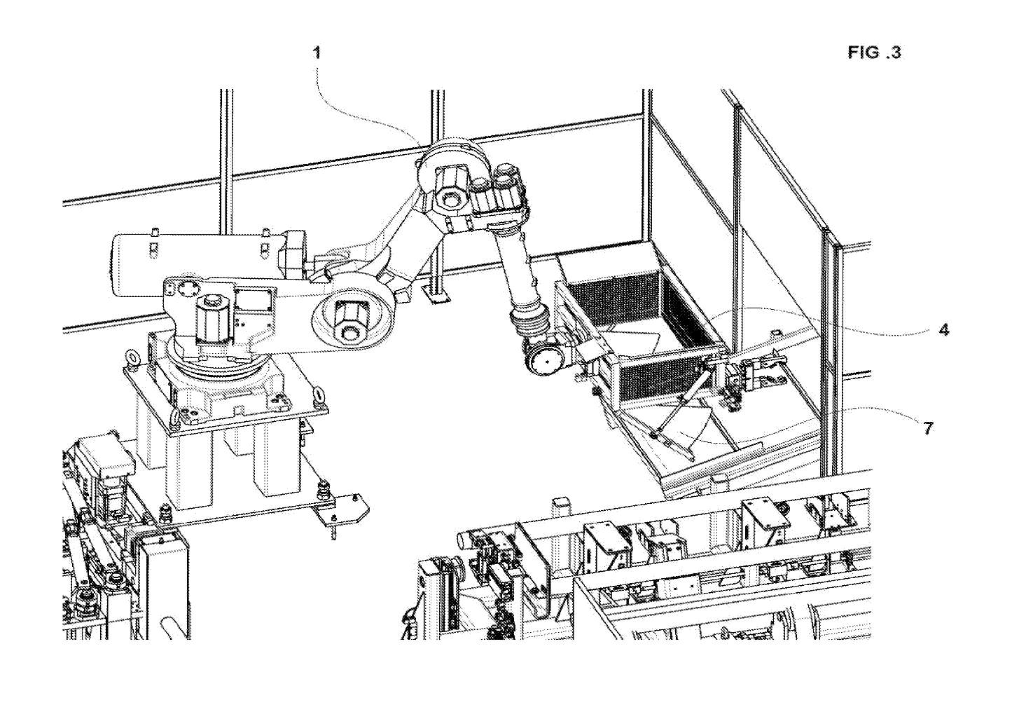

What is claim is:

1. Equipment for taking a bent pipe comprising a mechanical arm operated by first means controlled by at least one first electronic device provided with at least one container located at an end of the arm being the first device is electronically programmable and the arm is programmable with at least three degrees of freedom wherein the container is provided with at least one second device facilitating the unloading of the bent pipe into the container.

2. Equipment for taking a bent pipe according to claim 1, wherein the container is provided with second means suitable for unloading the bent pipe from the container.

3. Equipment for taking a bent pipe according to claim 1, wherein the container is provided with third means suitable for closing the container.
